(19) United States
(12) Patent Application Publication
(10) Pub. No.: US 2022/0026039 A1
(43) Pub. Date: Jan. 27, 2022

(54) Straight-Ahead Vehicle Signal

(71) Applicant: Mike Jennings, Frederick, MD (US)

(72) Inventor: Mike Jennings, Frederick, MD (US)

(21) Appl. No.: 17/379,222

(22) Filed: Jul. 19, 2021

Related U.S. Application Data
(60) Provisional application No. 63/055,001, filed on Jul. 22, 2020.

(51) Int. Cl. F21S 43/14; B60Q 1/26; B60Q 1/34

(52) U.S. Cl. CPC F21S 43/14; B60Q 1/2696; F21Y 2115/10; B60Q 1/346; B60Q 1/2615

(57) ABSTRACT

The present invention relates to a vehicular lighting device designed to be removably attached to a front and/or rear portion of a vehicle, and that is designed to signify intended straight-ahead travel of the vehicle. The device is comprised of a plurality of LED strips recessed under opaque glass wherein each LED strip is in a vertical arrow or chevron shape. An operator can selectively activate the lights wirelessly and upon reaching an area where a straight-ahead signal is desired, the operator can activate the system and illuminate the LED strips to visually communicate with surrounding motorists. The lights can automatically deactivate after a predetermined time. The vehicular lighting device can be integrated within or retrofitted to almost any type of vehicle, including but not limited to, cars, pickup trucks, commercial trucks, motorcycles, motorcycle helmets, bicycles, and more.

### CROSS-REFERENCE TO RELATED APPLICATION

The present application claims priority to, and the benefit of, U.S. Provisional Application No. 63/055,001, which was filed on Jul. 22, 2020 and is incorporated herein by reference in its entirety.

### FIELD OF THE INVENTION

The present invention relates generally to the field of driving assistance systems. More specifically, the present invention relates to a new and improved lighting system for vehicles such as cars, trucks, SUVs, motorcycles and other vehicles, which is designed, if used properly, to signify straight-ahead travel and works in conjunction with standard vehicle turn signals. The straight-ahead signal lighting system allows motorists and pedestrians to identify straight-ahead travel and effectively improve roadway safety. The invention reduces the chance of serious accidents occurring due to misunderstood communications and signals and may save the lives of many people. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, thousands of people lose their lives in traffic accidents every year. Further, over four million people are injured every year in the united States due to vehicle accidents. People who fail to obey traffic signals or miscommunicate signals put not only themselves, but other motorists in danger of accidents and serious injuries. It may be incredibly difficult to identify when a motorist is attempting to move straight-ahead at a stop light, stop sign, road fork, etc., thereby putting others in the path of the motorist and at risk of an accident. Motorists may use indicators on their vehicles to demonstrate to others that they are turning or moving towards a left direction or a right direction. However, motorists may be unable to signal to others in situations where they are planning to move straight-ahead. Others being unaware of the pending straight-ahead movement of the motorists may suffer from serious injuries and accidents. Particularly at nighttime, motorists or pedestrians at stop lights, stop signs, road forks, etc. may be unaware of exactly which direction another vehicle is intending to travel. Even if the motorists use nodding and hand gestures to signal to others regarding their intended movement direction, such hand gestures may not be visible to others, thereby causing inconvenience, confusion and danger to the people travelling on the road. Additionally, using hand gestures means taking one's hands off the steering wheel, which makes the situation even more dangerous, and can lead to serious accidents.

Further, while travelling on high-speed roadways and expressways, it becomes too dangerous to take the hands off the wheel and use hand gestures to indicate the movement direction such as straight-ahead. Furthermore, even if the motorists use hand gestures and nodding to signal their intended movement direction, there is still a chance that their communication will be misunderstood by others. In cases where such communication is misunderstood, it can potentially lead to serious injuries and deaths.

Therefore, there exists a long felt need in the art for a signaling system for vehicles that can be used to notify others that the vehicle is intending to move in a straight-ahead direction. There is also a long felt need in the art for a signaling system that makes it easy to indicate straight-ahead movement at a stop light, stop sign, road fork, etc. Additionally, there is a long felt need in the art for a signaling system that eliminates the need to use nodding and hand gestures for indicating the direction of one's vehicle movement to others. Moreover, there is a long felt need in the art for a signaling system to indicate straight-ahead movement during nighttime or at times when the visibility is significantly reduced (i.e., dusk, dawn and during inclement weather conditions). Further, there is a long felt need in the art for a straight-ahead signaling system that eliminates the need to take one's hands off the steering wheel in order to indicate the intended direction of travel. Finally, there is a long felt need in the art for a straight-ahead signaling system that reduces the chances of serious accidents and ensures the safety of motorists and pedestrians.

The subject matter disclosed and claimed herein, in one embodiment thereof, comprises an illuminating device indicating straight-ahead movement of a vehicle on which the illuminating device is mounted. The illuminating device comprises: a plurality of illuminating sources; each illuminating source is a LED strip in the form of a chevron or arrow; the plurality of LED chevrons are oriented in a vertical stack cluster, with space between each of the LED chevron strips; a transparent cover to protect the LED strips; a plurality of mounting fasteners to mount the illuminating device on the surface of a vehicle; a wireless module to wirelessly connect to a control device for remotely controlling the operation of the LED strips; an internal battery to provide power to the LED strips; and, a timer circuit preconfigured with a time value for which the LED strips flash. The LED strips can flash sequentially in an upward direction from a lowermost chevron to an uppermost chevron, and can flash individually and then flash simultaneously. The LEDs flash in the direction of the vehicle's straight-ahead movement and can include a solar panel to recharge the internal battery.

In this manner, the novel straight-ahead indicating light device of the present invention accomplishes all of the forgoing objectives, and provides a relatively safe, easy, convenient and effective solution to indicate the intended straight-ahead movement of the vehicle to others. The straight-ahead indicating light device of the present invention is also user friendly, as it makes other people aware of the intended vehicle movement direction during nighttime, or when the visibility is significantly reduced (such as dusk, dawn or during inclement weather). The invention eliminates the need to use hand or head gestures to signal to others, and prevents motorists and pedestrians from serious or fatal accidents.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description which is presented later.

The subject matter disclosed and claimed herein, in one potential embodiment thereof, comprises an illuminating device indicating straight-ahead movement of a vehicle on which the illuminating device is mounted. The illuminating device comprises: a plurality of illuminating sources; each illuminating source is an LED strip in the form of a chevron or arrow; the plurality of LED chevrons are oriented in a vertical stack cluster with space between each of the LED chevron strips; a transparent cover to protect the LED strips; a plurality of mounting fasteners to mount the illuminating device on a surface of a vehicle; a wireless module to wirelessly connect to a control device for remotely controlling the operation of the LED strips; an internal battery to provide power to the LED strips; and, a timer circuit preconfigured with a time value for which the LED strips flash. The LED strips can flash in an upward direction towards the arrowhead, and can flash individually and then flash simultaneously. The LEDs flash in the direction of the vehicle straight-ahead movement, and can include a solar panel to recharge the internal battery.

In a further embodiment of the present invention, a vehicular lighting device configured to be removably attached to the front and rear portion of a vehicle and designed to indicate the straight-ahead movement of the vehicle is disclosed. The vehicular lighting device comprises: a rectangular main body having a plurality of LED strips for illumination; each LED strip having a plurality of LED beads and is in the shape of a chevron or vertical arrow having the apex of the chevron pointed upward; a plurality of mounting fasteners such as suction cups to mount the vehicular lighting device on a surface of a vehicle; and, each LED strip flashes in a single color to indicate the straight-ahead movement of the vehicle. The LED strips feature arrow-shaped blue, green and purple lights flashing in an upward sequence toward the uppermost LED strip, first individually, then simultaneously before being deactivated after a predetermined time period or a manual operation by a user. The vehicular lighting device may or may not require the electrical power supply of the vehicle on which the device is mounted.

In yet a further embodiment of the present invention, a method of indicating to surrounding motorists and other individuals about the straight-ahead movement of a vehicle using a straight-ahead signal device mounted on a front and rear surface of the vehicle is disclosed. The method of signaling comprises: mounting the straight-ahead signal device on the front windshield and/or rear windshield of the vehicle; wirelessly connecting the straight-ahead signal device to a remote control device such as a key ring, or a button on the dashboard of the vehicle; activating the straight-ahead signal device; and, illuminating the light sources of the device by sending an instruction from the remote control device wherein the light sources flash in arrow-shaped blue, green and purple lights in an upward direction for a predetermined period of time to indicate the straight-ahead movement of the vehicle.

In another potential embodiment, the straight-ahead signal device includes a solar-powered lithium battery and comprises three LED strips. Each strip can include 12, 16, or 24 super bright LED beads that distinctly identify the straight-ahead direction of the vehicle. The device is easy to install and can be mounted on an exterior or interior surface of the windshield of a vehicle. No external wires or electrical connections are required for the installation and use of the illumination device.

The lighting device and method of the present invention, if used properly, provides cars, trucks, SUVs, motorcycles and other vehicles with a new and improved lighting system designed to signify straight-ahead travel, and may work in conjunction with standard vehicle turn signals to add functionality to a vehicle. The invention allows motorists and pedestrians to identify straight-ahead travel and effectively improve roadway safety. The device of the invention attaches to the front and/or the rear vehicle windshields via suction cups, and can be powered with a battery, solar panels, or activated in conjunction with the vehicle's existing electrical systems. The lighting device maintains proper roadway safety at multi-turn lane intersections, four-way stops and major expressways with multi-turn lanes. The invention offers a simple vehicle attachment to reduce the chance of serious accidents, especially useful at times of day when visibility is significantly reduced (i.e., dusk, dawn and during inclement weather).

To the accomplishment of the foregoing and related ends, certain illustrative aspects of the disclosed innovation are described herein in connection with the following description and the annexed drawings. These aspects are indicative, however, of but a few of the various ways in that the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a plan view of one potential embodiment of the straight-ahead signal device of the present invention in accordance with the disclosed structure;

FIG. 2 illustrates a diagrammatic view showing the various components for the illumination of the LED strips of one potential embodiment of the straight-ahead signal device of the present invention in accordance with the disclosed structure;

FIG. 3 illustrates a wireless connection between one potential embodiment of the straight-ahead signal device of the present invention and a key ring having a control button in accordance with the disclosed structure;

FIG. 4 illustrates a connection between one potential embodiment of the straight-ahead signal device of the present invention and a dashboard having a control button in accordance with the disclosed structure;

FIG. 5 illustrates a wired circuit diagram of a vehicle showing connection with one potential embodiment of the straight-ahead signal device of the present invention in accordance with the disclosed structure;

FIG. 6 illustrates the use of one potential embodiment of the straight-ahead signal device of the present invention positioned on the front windshield of a vehicle in accordance with the disclosed structure; and

FIG. 7 illustrates the use of one potential embodiment of the straight-ahead signal device of the present invention on the rear portion of a motorcycle in accordance with the disclosed structure.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a signaling system for vehicles that can be used to signal to others that the vehicle is intending to move in a straight-ahead direction. There is also a long felt need in the art for a signaling system that makes it easy to indicate straight-ahead movement at a stop light, stop sign, road fork, etc. Additionally, there is a long felt need in the art for a signaling system that eliminates the need to use nodding and hand gestures for indicating the direction of vehicle movement to others. Moreover, there is a long felt need in the art for a signaling system to indicate straight-ahead movement during nighttime or at times when the visibility is significantly reduced (i.e., dusk, dawn and during inclement weather conditions). Further, there is a long felt need in the art for a straight-ahead signaling system that eliminates the need to take one's hands off the steering wheel in order to indicate the intended direction of travel. Finally, there is a long felt need in the art for a straight-ahead signaling system that reduces the chances of serious accidents and ensures the safety of motorists and pedestrians.

The present invention, in one exemplary embodiment, comprises an illuminating device indicating straight-ahead movement of a vehicle on which the illuminating device is mounted. The illuminating device comprises: a plurality of illuminating sources; each illuminating source is a LED strip in the form of a chevron or arrow; the plurality of LED chevrons are oriented in a vertical stack cluster with space between each of the LED chevron strips; a transparent cover to protect the LED strips; a plurality of mounting fasteners to mount the illuminating device on a surface of a vehicle; a wireless module to wirelessly connect to a control device for remotely controlling the operation of the LED strips; an internal battery to provide power to the LED strips; and, a timer circuit preconfigured with a time value for which the LED strips flash. The LED strips can flash repeatedly in an upward sequence from a lowermost LED strip to an uppermost LED strip until reaching a predeterminable time period. After a predeterminable time period, all of the LED strips can flash simultaneously. The LEDs flash in the direction of the vehicle straight-ahead movement and can include a solar panel to recharge the internal battery.

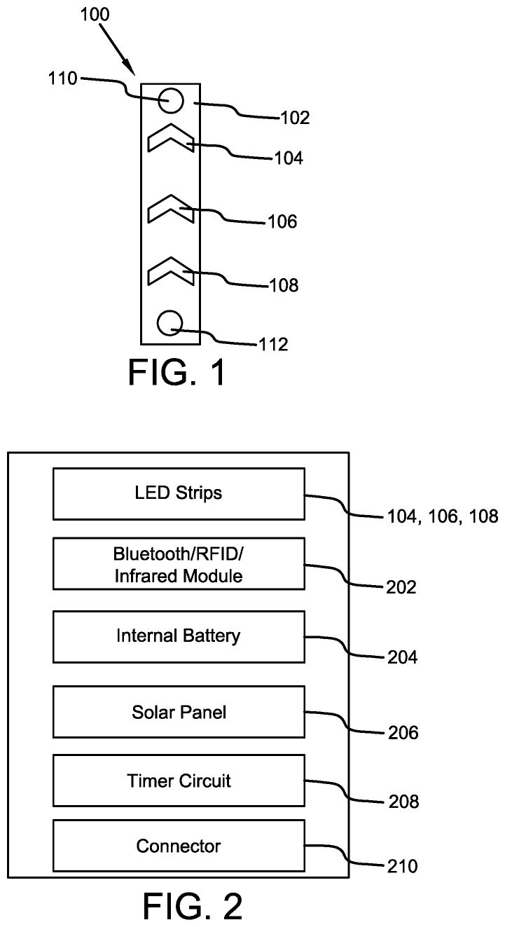

Referring initially to the drawings, FIG. 1 illustrates a plan view of one potential embodiment of the straight-ahead signal device 100 of the present invention in accordance with the disclosed structure. The straight-ahead signal device 100 is a signaling system for almost any type of vehicle, and is designed to signify straight-ahead travel of the vehicle. In contrast to standard turn signals that signify only a left turn or a right turn, the straight-ahead signal device 100 of the present invention signifies that a vehicle will move, or intends to move, in a straight or relatively straight direction. The straight-ahead signal 100 can work with standard vehicle turn signals to add functionality to a vehicle, allowing motorists and pedestrians to identify intended straight-ahead travel and effectively improve roadway safety. The straight-ahead signal device 100 is removably attached to the front and/or rear portions of a vehicle, such as to a vehicle windshield using attachment mechanisms 110, 112, such as suction cups. Alternative attachment means, such as an adhesive sheet or an adhesive tape, can be used to adhere the straight-ahead signal device 100 to a vehicle surface.

The straight-ahead signal device 100 is a generally rectangular device having a rectangular base surface 102 on which a plurality, and in one exemplary embodiment three LED strips 104, 106, 108 are present. Each of the LED strips is mounted on a printed circuit board (PCB) embedded in the base surface 102 and each LED strip flashes in a different color. In one potential embodiment, each LED strip is in the shape of a chevron extending across the width of the base surface 102 and may be blue, green or purple in color. Each LED strip includes a plurality of light-emitting diodes that illuminate in a single color. The LED strips 104, 106, 108 can be sequenced to flash the LED strips from the lowermost LED strip 108 to the uppermost LED strip 104 of the base surface 102, wherein each LED strip flashes sequentially for a predetermined period of time and then all the LED strips 104, 106, 108 can flash simultaneously before the flashing turns off. Sequential flashing can be in the following order: first LED 108; second LED 108+LED 106; third LED 108+LED 106+LED 104; fourth all LEDs off; fifth LED 108; sixth LED 108+LED 106; seventh LED 108+LED 106+LED 104; eighth all LEDs off; etc., and continuing in that order until a predetermined period of time is reached.

The straight-ahead signal device 100 does not require complex installation and is easily replaceable. The straight-ahead signal device 100 improves passerby visibility and communicates the straight-ahead intended motion of the vehicle on which the device 100 is mounted to surrounding motorists, vehicles and pedestrians. The signaling device 100 can be integrated with a vehicle during manufacturing or retrofitted to almost any type of vehicle, including but not limited to, cars, pickup trucks, commercial trucks, motorcycles, motorcycle helmets, bicycles and more.

The fastening mechanism 110, 112 can be present near the ends of the device 100 such that the LED illumination is not obstructed, and can be seen clearly by surrounding motorists. The fastening mechanism 110,112 can work on any type of metal surface, plastic surface, polymer surface or glass associated with any type of vehicle, to install the signaling device 100 on the vehicle. The device 100 can come in different sizes to meet the requirements based on the shape and size of different vehicles. The signaling device 100 is a simple vehicle attachment that can be easily placed and removed on any portion of the vehicle, to reduce the chance of serious accidents, and is particularly useful during the night and those portions of the day when visibility is significantly reduced.

The signaling device 100 can be mounted vertically on the inside edge of the front and rear windshields of a vehicle and is thereby less susceptible to theft and vandalism as the installation is done on the inside edge of the vehicle. When the vehicle is not in use, the signaling device 100 can be removed easily and can subsequently be installed again using the reusable fastening mechanism 110, 112. The base surface 102, upon installation, conforms to the shape of the mounted surface and provides a clear view of the flashing LED lights to anyone within eyesight of the device 100.

Each LED strip 104, 106, 108 can have up to 30 LED beads, and each strip is connected to a battery. The device 100 can use a built-in solar panel for providing power to the LED strips. The PCB, batteries and other components, to be described in more detail hereinafter, are embedded in the base surface 102. The device 100 increases the aesthetic appearance of the vehicle in addition to providing for the safety of the occupants of the vehicle and other surrounding motorists. In one embodiment, each LED strip 104, 106, 108 can be powered by the electrical power of the vehicle through the electronic control unit (ECU) wiring of the vehicle.

FIG. 2 illustrates a diagrammatic view showing the various components for the illumination of the LED strips of one potential embodiment of the straight-ahead signal device 100 of the present invention in accordance with the disclosed structure. More specifically, the LED strips 104, 106, 108 are present on the PCB and flash in a color to signify straight-ahead motion of a vehicle. The LED strips are covered with a waterproof transparent cover, especially for use with motorcycles, motorcycle helmets, bicycles, bicycle helmets, and more. The adhesive or the suction cups are also waterproof and include a long reusable life. The beads of the LED strips illuminate for a predeterminable period of time to provide safety to the motorists.

The LED strips 104, 106, 108 can be activated wirelessly using a button mounted to a key ring. The device 100 includes a Bluetooth/RFID module 202 to wirelessly connect to the wireless key ring, thereby allowing a user to operate the LED strips 104, 106, 108 using the key ring. Alternatively, the LED strips 104, 106, 108 can be activated using a control button on a dashboard, or on the driver side visor. The control button can be wirelessly connected to the signaling device 100 or can be connected through the electronic control unit (ECU) of the vehicle.

The signaling device 100 includes an internal battery 204 to power the LED strips, and an optional small solar panel is present to convert solar energy into electrical energy, which can be stores in the internal battery 204 until needed. This allows the device 100 to be independent of the electrical power and the ECU of the vehicle, and is useful in cases of retrofitting of the device 100, since it does not require any additions or modifications in the circuity of the vehicle.

The LED strips present in the straight motion device 100 can deactivate after a predeterminable or preconfigured time duration such as ten seconds. A time circuit 208 is present in the device 100 that tracks the duration of activation time, compares the active duration to the preconfigured time duration, and deactivates the LED strips after the preconfigured time value has been reached. Also, the LED strips can be deactivated by the operator using the control button on a key ring, dashboard or any other location.

In situations where the device 100 and its components are provided power by the electrical energy of the vehicle, a connector 210 can be used to connect the device to the wiring and ECU of the vehicle. This is useful in the situations where the device 100 is installed during the manufacturing process of the vehicle.

It should be noted that all the components are sealed and waterproof. The battery 204 can be a button battery and the solar panel can have solar diodes to recharge the battery 204 to provide power to the LED strips. The wireless control of the device 100 does not alter the original wire lines of the vehicle. The device 100 works well in low-light areas, at night and on rainy days. The device 100 eliminates the need to nod or hand gesture to another by the operator of the vehicle when attempting to move straight-ahead at a stop light, stop sign, road fork or the like.

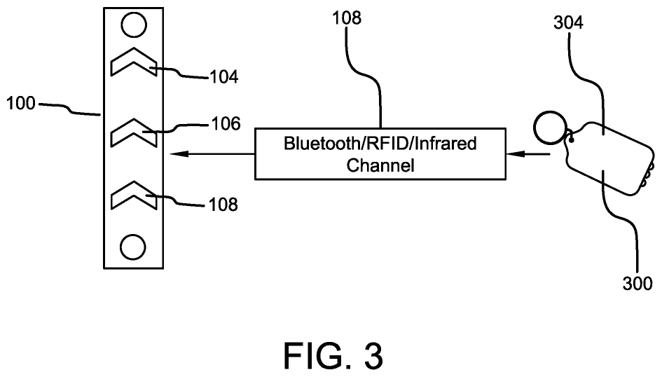

FIG. 3 illustrates a wireless connection between one potential embodiment of the straight-ahead signal device 100 of the present invention and a key ring having a control button in accordance with the disclosed structure. More specifically, FIG. 3 illustrates a wireless connection between the straight-ahead signal device of the present invention and a key ring having a control button in accordance with the disclosed structure. The signaling device 100 of the present invention can come commercially with a wireless key ring 300 in the form of a key fob and includes a control button 304 to control the operation of the LED strips 104, 106, 108.

The key ring 300 includes a Bluetooth/RFID/Infrared transceiver that pairs with the Bluetooth/RFID/Infrared Module of the device 100. Once paired, the control button 304 is used to transmit wireless instructions to the device 100 for activation or deactivation. Upon reaching an area where a straight-ahead signal is desired, a user, such as the driver of the vehicle, can activate the device 100 and illuminate the LED strips using the control button 304. The illuminated LED strips, in a pointed stacked chevron arrangement, visually communicates the intended straight-ahead direction of travel with surrounding motorists. The driver can also deactivate the illumination of the LED strips using the control button 204.

The key ring 300 is paired with the straight-ahead motion device 100 in a manner similar to conventional pairing, using Bluetooth, 5G, RFID, NFC or any other wireless medium between two devices. In one embodiment, the speed of the flashing lights can also be altered using the control button 304.

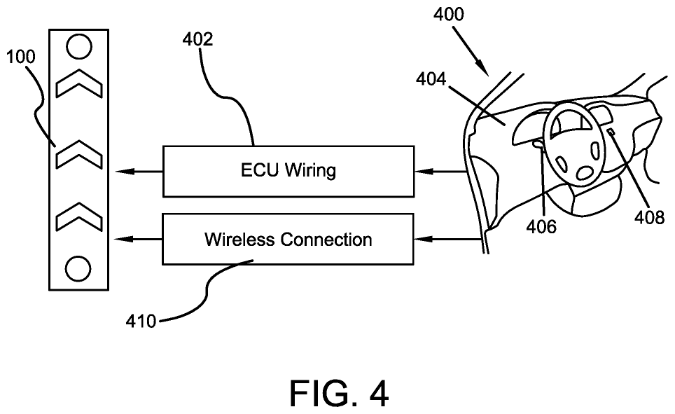

FIG. 4 illustrates a connection between one potential embodiment of the straight-ahead signal device 100 of the present invention and a dashboard having a control button in accordance with the disclosed structure. As discussed above, the straight-ahead signal device 100 can be integrated to a vehicle's ECU. A control button 408 can be installed on the dashboard 404 of the vehicle 400 to activate or deactivate the signal device 100.

The control button 408 can be connected wirelessly using the wireless transceiver of the dashboard 404 through a wireless connection 410. Alternatively, the control button 408 can be connected to the signal device 100 using ECU wiring or any other electrical connection of the vehicle. The connection can be made similar to the connection that the turn signal strobe 406 makes with a conventional turn signal of the vehicle 400. The control button 408 is easily accessible to a user, and can easily control the signal device 100 and the LED strips of the device 100.

Using an internal battery of the straight motion device 100, in one arrangement the LED strips can be illuminated whether the vehicle is on or off. A user can manually deactivate the device 100 when the device 100 is not required to be illuminated. In one embodiment, the device 100 can have a light sensor that senses the ambient daylight and turns on the LED strips when minimal or no ambient light is detected. The body of the device 100 is completely sealed and is lightweight and portable. The LED strips, when illuminated, draw power from the internal rechargeable batteries or the vehicle's electrical power.

The fastening mechanism(s) of the device 100 includes a strong grip for mounting onto a smooth surface of the vehicle, such that the device 100 is stably retained thereto and does not move while the vehicle is in motion. It should be appreciated that the device 100 is portable and can be used on any vehicle to function as a means of illumination to identify the vehicle.

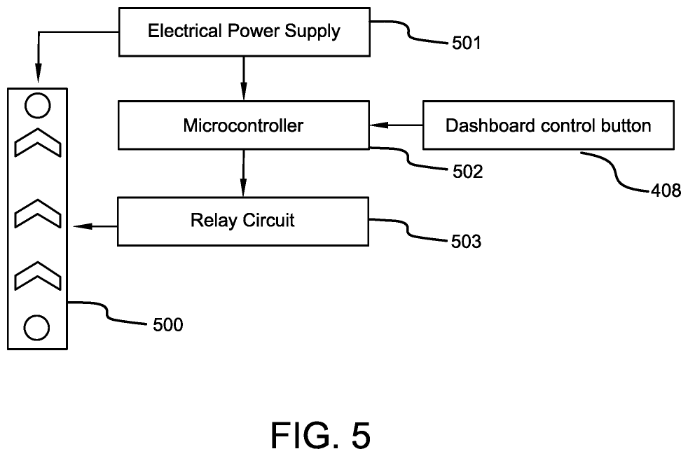

FIG. 5 illustrates a wired-circuit diagram of a vehicle showing connection with one potential embodiment of the straight-ahead signal device 100 of the present invention in accordance with the disclosed structure. As shown, in the present embodiment, an electrical power supply 501 of a vehicle provides power to the straight-ahead signal device 100. On pushing a control button present on the dashboard 408 of a vehicle, or on any surface of a motorcycle or a visor, the instruction is transmitted to a microcontroller 502 of the vehicle and accordingly a wired circuit 503, such as a relay circuit, activates or deactivates the device 100. A connector is used for connecting the circuit of the vehicle to the device 100. The wired circuit 503 logic can be wired such that when a right or left turn signal is activated on the vehicle, the straight-ahead signal device 100 is automatically turned-off. Additionally, the wired circuit 503 logic can be wired such that when the straight-ahead signal device 100 is activated, the right and left turn signals are automatically turned-off

In an alternative embodiment, the control button can control the device 100 using the wired circuit 503, however the device 100 can be powered by an independent power source as described above. The device 100 is preferably controlled in a wireless manner, however the wired connection to control the device 100 is also supported by the present disclosure.

In a further alternative embodiment, an electronic device such as a smartphone, PDA, tablet or any other similar device can also control the straight-ahead motion device 100 via a wireless connection, using wireless communication technology known in the art such as NFC, Infrared, Bluetooth, RFID, etc. with the device 100.

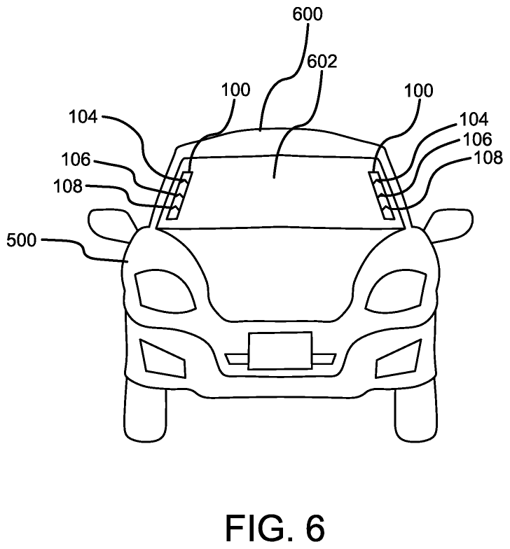

FIG. 6 illustrates the use of one potential embodiment of the straight-ahead signal device 100 of the present invention positioned on the front windshield of a vehicle in accordance with the disclosed structure. More specifically, the straight-ahead signal device(s) 100 attaches to a front windshield 602 of a car 600 via the fastening mechanism, such as suction cups present at a top end and a bottom end of the straight-ahead motion device 100. The device 100 is installed such that the chevron-shaped LED strips 104, 106, 108 have the apex pointed in an upward direction. The signaling device 100 is integrated within or retrofitted to the car 600 and can be mounted vertically on the inside edge(s) of the front windshield 602 of the car 600. The device 100 mounted inside the car 600 is less susceptible to theft and vandalism.

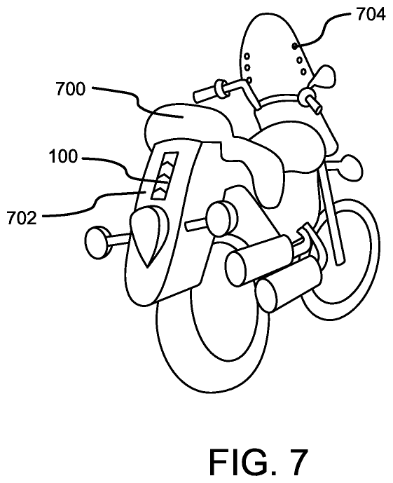

FIG. 7 illustrates the use of one potential embodiment of the straight-ahead signal device 100 of the present invention on the rear portion of a motorcycle in accordance with the disclosed structure. More specifically, the straight-ahead signal device 100 of the present invention can be used to adhere to the rear portion 702 of a motorcycle 700. The device 100 is removably-attached to the rear portion 702 using the fastening mechanisms. Additionally, the device 100 can be controlled wirelessly or through a control button 704 present on the motorcycle 700. The device 100 in the present embodiment is waterproof, tamper resistant, and corrosion free. The light assembly of the device 100 can be recessed under opaque glass, or transparent plastic, and can feature, in one illustrative example, chevron-shaped blue, green and purple lights, flashing in an upward repeating sequence direction from the lower light 108, to the middle light 106 and then to the upper light 104.

The color of the LED strips can vary and the style of illumination such as blinking, static, or sequential can be set as per the user's needs and/or preferences. The device 100 can be attached to the front or rear of a vehicle to illuminate and identify intended straight-ahead movement of the vehicle. Additionally, the device 100 of the present invention is generally rectangular but can be of any suitable shape and size, including but not limited to, cubic, pyramidal, cylindrical, spherical or any other shape. The device 100 can further comprise logos, indicia, trademarks, geometric patterns, customizable colors and fonts, embroidery, prints and/or other images on its surface.

The straight-ahead signal device 100 of the present invention may be made commercially available in a packing of a single unit, or also in packaging of six units or twelve units. The device 100 can be used on cars, trucks and related vehicles, road and construction sites, public zones, airports, highways, warehouses, dangerous operation sites and related transportation usages. Furthermore, existing highway and/or street signs can be modified to include reflective arrows of the same color scheme as the straight-ahead signal device 100, to correspond with the direction the motorist is traveling in. Overall, the entirety of the system is intended to improve roadway safety, and in turn, save lives.

Certain terms are used throughout the following description and claims to refer to particular features or components. As one skilled in the art will appreciate, different persons can refer to the same feature or component by different names. This document does not intend to distinguish between components or features that differ in name but not structure or function. As used herein “straight-ahead signal device”, “signaling device”, “signal”, “straight motion device”, and “device” are interchangeable and refer to the straight-ahead signal device 100 of the present invention.

Notwithstanding the forgoing, the straight-ahead signal device 100 of the present invention can be of any suitable size and configuration as is known in the art without affecting the overall concept of the invention, provided that it accomplishes the above-stated objectives. One of ordinary skill in the art will appreciate that the size, configuration and material of the straight-ahead signal device 100 as shown in the FIGS. are for illustrative purposes only, and that many other sizes and shapes of the straight-ahead signal device 100 are well within the scope of the present disclosure. Although the dimensions of the straight-ahead signal device 100 are important design parameters for user convenience, the straight-ahead signal device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What includes been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An illumination device configured to signal an intended straight-ahead direction of a movement of a vehicle, the illumination device comprising:
a plurality of LED strips mounted to a base, wherein each of said plurality of LED strips comprises a chevron shape;
said plurality of LED strips mounted to said base in a vertical stack orientation with a space between each of said plurality of LED strips;
a mounting mechanism attached to said base for mounting the illumination device to the vehicle, wherein said base and said mounting mechanism comprise a flexible material for mounting to a non-planar surface of the vehicle;
a timer for sequentially illuminating said plurality of LED strips in a repeating order starting with a lowermost LED of the plurality of LED strips and sequentially illuminating a subsequent LED directly above said lowermost LED; and
a Bluetooth module for wireless connection to a remote device, wherein said remote device is a controller for operating the illumination device.

2. The illumination device of claim 1, wherein said mounting mechanism is selected from a group consisting of a suction cup and an adhesive.

3. The illumination device of claim 1, wherein said plurality of said LED strips comprise a set of three chevrons wherein each of said set of three chevron comprises a different color LED.

4. The illumination device of claim 1, wherein said plurality of said LED strips comprise a set of three chevrons wherein each of said set of three chevrons comprises a same color LED.

5. The illumination device of claim 2 further comprising a connector for connection of the illuminating device to a vehicle power supply for powering said illuminating device.

6. The illumination device of claim 2 further comprising a battery for powering said illuminating device.

7. The illumination device of claim 6, further comprising a solar panel for recharging said battery.

8. An illumination device configured to signal an intended straight-ahead direction of a movement of a vehicle, the illumination device comprising:
a plurality of LED strips mounted to a base, wherein each of said plurality of LED strips comprises a chevron shape, and further wherein each of said plurality of LED strips is mounted to said base in a vertical stack orientation with a space between each of said plurality of LED strips;
a mounting mechanism attached to said base for mounting the illumination device to the vehicle, wherein said base and said mounting mechanism comprise a flexible material for mounting to a non-planar surface of the vehicle; and
a timer for sequentially illuminating said plurality of LED strips in a repeating order starting with a lowermost LED chevron and sequentially illuminating another LED chevron directly above said lowermost LED chevron, wherein said timer simultaneously illuminates all of said plurality of LED strips after said sequentially illuminating.

9. The illumination device of claim 8, further comprising a Bluetooth module for wireless connection to a remote device, wherein said remote device is a controller for operating the illumination device.

10. The illumination device of claim 9, wherein said mounting mechanism is selected from a group consisting of a suction cup and an adhesive.

11. The illumination device of claim 10, wherein said plurality of LED strips comprises a set of three chevrons, wherein each of the set of three chevrons includes a different color LED.

12. The illumination device of claim 10, wherein said plurality of LED strips comprises a set of three chevrons, wherein each of the set of three chevrons includes a same color LED.

13. The illumination device of claim 9 further comprising a connector for connection to a power supply of the vehicle for powering said illuminating device.

14. The illumination device of claim 9 further comprising a battery for powering said illuminating device.

15. The illumination device of claim 14 further comprising a solar panel for recharging said battery.

16. A method of signaling an intended straight-ahead direction of travel for a vehicle, the method comprising the steps of:
providing a flexible illumination device with a plurality of LED strips;
mounting said plurality of LED strips to a base in a vertical stack orientation with a space between each of said plurality of LED strips;
mounting said base to the vehicle;
selectively illuminating said plurality of LED strips sequentially in a repeating order starting with a lowermost LED strip;
sequentially illuminating second LED strip directly above said lowermost LED strip until reaching an uppermost LED strip;
turning off all of said plurality of LED strips; and
repeating said sequential illumination of said plurality of LED strips from said lowermost LED strip to said uppermost LED strip for a predeterminable period of time.

17. The method of claim 16 further comprising the step of simultaneously illuminating all of said plurality of LED strips after said predeterminable period of time.

18. The method of claim 16, wherein each of said plurality of LED strips comprises a chevron shape.

19. The method of claim 16 further comprising the step of automatically turning off said flexible illumination device when a right or a left vehicle turn signal is activated.

20. The method of claim 16 further comprising the step of automatically turning off a right and a left vehicle turn signal when said flexible illumination device is activated.
